(19) United States
(12) Patent Application Publication
(10) Pub. No.: US 2008/0010131 A1
(43) Pub. Date: Jan. 10, 2008

(54) Customer loyalty system and method

(76) Inventors: Thomas L. Bridges, Melbourne Beach, FL (US); Anthony P. Galluscio, Indialantic, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 11/454,270

(22) Filed: Jun. 16, 2006

(51) Int. Cl. G06Q 30/00

(52) U.S. Cl. 705/14

(57) ABSTRACT

The invention is a method and apparatus for storing and communicating information between a customer and proprietor, enabling the proprietor to build a database of customer information and enabling the customer to build a database of information from businesses participating in the system of the invention. Customers provide information only to those proprietors they choose and automatically receive business contact information and other important information (including but not limited to store hours, special deals). Examples of the customer information to be stored by the business are contact information such as address and telephone information, shopping habits, amounts purchased, photographs, demographic data, date of initiation into the customer loyalty program, and the like. The invention enables the proprietor to analyze customer habits and communicate special offers or customer rewards to specific classes of customers. The customer utilizes a handheld personal information device to store personal information such as name, address, telephone number, email address, and other customer information. The personal information unit transmits said personal information to, and may receives information from, an information exchange unit upon entry of the customer onto the proprietor's business premises. Customer personal information and shopping metrics are recorded in a relational database. The business proprietor establishes reward criteria specific to his business and utilizes the system of the invention to analyze customer shopping habits, demographic information, and geographic information; and the system of the invention is furthermore used to reward customer loyalty.

### CROSS REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### BACKGROUND OF THE INVENTION

1. Field of the Invention

The invention relates to the field of products and systems intended for use in aiding merchants in collecting and organizing customer information, and utilizing such information to increase customer loyalty and reward frequent procurement of the merchant's goods or services or frequent visitation of the merchant's place of business. Such loyalty programs improve business-customer relationships and enhance the merchant's profitability. Examples of such loyalty programs include individualized identification cards with bar codes or magnetic stripes containing customer identification information which are utilized by Point Of Sale (POS) systems in grocery stores, and frequent flyer programs utilized by airlines to track the number of miles flown by a particular customer. Rewards can be awarded based upon frequency of use, number of miles flown, amount of purchases made within a given time, or other metrics as determined by the merchant.

2. Background Art

Proprietors of businesses have long sought to understand basic market information relating to particular customers who are most likely to make use of the proprietor's business. Examples of the kind of customer information typically sought include geographical location, age, gender, income level, shopping habits, eating habits, frequency of use of the proprietor's business products or services, amount of purchases made at the proprietor's place of business, frequency of use of proprietor's business products or services as a function of days of the week or months of the year, and the like. Such information can be extremely valuable to the proprietor as the proprietor seeks to analyze the market for the purpose of spending marketing and advertising funds more wisely, and for the purpose of making other business decisions such as where and when to open additional places of business, where and how to market his business, and so on. Furthermore, the business proprietor often utilizes such market information to reward customers who frequent his place of business, who make large purchases, or who consistently bring other customers to the place of business. Such rewards programs are commonly known as customer loyalty programs.

One of the oldest known techniques for gathering this information is a simple jar placed in full view at the proprietor's place of business, sometimes simply called the “fish bowl”, in which customers simply drop their business card or other identifying paper. This technique is cumbersome and is not readily adaptable for use in connection with a number of proprietor places of business, nor is it readily adaptable for use utilizing electronic data bases for data reduction and analysis utilizing software techniques. The fish bowl techniques are also non-secure in that any information dropped into the jar is easily stolen by other customers, un-loyal employees, and the like.

Other customer loyalty systems have been conceived which utilize Point Of Sale (POS) devices to capture customer information. These systems collect information when the customer makes a purchase at a merchant's place of business by utilizing a special magnetic or bar-coded card which is swiped or read at the time of purchase. Information from the card is then processed to allow the merchant to observe various metrics associated with a particular customer. These metrics include the amount of purchases made by the customer, the home address of the customer, and the number of times a particular customer visits the place of business. These customer loyalty systems suffer from the drawback that the information is not collected until the customer actually makes a purchase at the point of sale. Accordingly, customers who enter a merchant's place of business without actually completing a purchase are not recorded by the customer loyalty system. Another drawback to these systems is that they are not easily adapted to some types of businesses such as restaurants, in which the customer may not actually approach a register, but may instead pay at the table. In the restaurant application, the point of sale is often the customer's dinner table, which does not easily lend itself for use in collecting such information.

Other customer loyalty systems have been conceived for use in internet-based transactions. In these systems, a customer typically places an order utilizing the World Wide Web, typically completing the transaction utilizing a credit card. The customer enters personal information directly by keying it into spaces provided on the merchant's internet web site utilizing a personal computer, and this information is stored and analyzed to allow a merchant to reward customer loyalty. These systems are not usable for business in which the transactions occur at a physical address, such as a restaurant, store, theatre, or the like.

It is therefore an object of the present invention to overcome the aforementioned shortcomings by providing a customer loyalty system that is simple to use, optimally operates at or near the entry point of the merchant's place of business and performs an exchange of data with a minimum of customer interaction, is secure regarding the customer's personal information, does not require equipment to be placed at a particular point of sale within the proprietor's place of business, and will record customer visits even if no purchase is made.

Customer loyalty systems have been disclosed which utilize a POS interface. U.S. patent application serial number US2004/0088221 A1, filed Jan. 3, 2002 by Katz et al., discloses a POS system that collects customer information and shares this information with a marketing company computer which processes the information in conjunction with a marketing data base. Customer data is compared to a data company data base for the purpose of identifying a particular customer with a block of other customers such that the amount of customer data to be analyzed is reduced and therefore manageable.

Another POS system is disclosed in U.S. Pat. No. 5,566,327, issued Oct. 15, 1996 to Sehr. This U.S. patent discloses a magnetic card or smart card based system for use by theme parks in which a customer is issued in magnetic or smart card coded with his personal information. When the card is presented at various points of sale within the theme park, personal information is recorded along with purchase information, such that a database can be constructed to analyze various aspects of customer behavior and to control customer rewards.

Customer loyalty programs based on POS have the distinct drawback that a customer must actually make a purchase before any information is recorded. No information is recorded when a customer simply enters a store to perform what is commonly known as a “window shopping”, in which the customer simply views, the merchants display without making a purchase. In these instances, it is desirable that a merchant know that the customer has at least made a visit to the store, as each visit represents a potential sale. It is therefore desirable that all customer visits to a particular place of business be recorded and rewarded

Other customer loyalty programs have been devised. The airline industry has long utilized frequent flyer reward programs that reward customers based upon the total number of miles flown, or the number of legs flown. These systems do not utilize a specific hardware interface; rather, they are information based systems in which the information used is input into computers by hand.

The loyalty systems of the prior art are generally employed by a single store or single chain of merchants, and therefore they are not configurable and usable by a plurality of small to medium sized local businesses or business chains. These local merchants are faced with the disadvantages related to limited staff, assets, and resources to develop their own loyalty and reward system due to the complexity and size of the effort required to develop and maintain such systems.

There is therefore a need for a customer information gathering and loyalty system which does not depend upon the making of a purchase by a customer for that customer to participate in the reward system, such as the POS systems described above. Furthermore, there exists a need for a customer loyalty system that is usable among a plurality of business entities and types, especially those businesses that are small to medium sized local businesses, and there exists a need for a customer loyalty system that is individually configurable by each merchant or business proprietor who participates in the system. A need therefore exists for a merchant-configurable system which is simple, easy to use, provides rewards and incentives to the customer, is available for use and able to be tailored to the individual needs of the small to medium sized business, and is based upon reliable technology.

### BRIEF SUMMARY OF THE INVENTION

The customer information and reward system of the present invention overcomes the aforementioned shortcomings of the systems of the prior art by providing a merchant-configurable system that can be tailored to provide the specific reward program envisioned by the merchant, and is especially beneficial to the small to medium sized business operation because it is simple to use, easy to maintain, and requires very little development by the business proprietor. The invention is a method and apparatus that enables businesses and consumers to exchange information, and furthermore enables the merchant, or business proprietor, to analyze customer data and to calculate and provide rewards to customers based upon metrics specifically tailored to the business. Consumers collect business information (address, phone, hours of operation, menu, etc.) from the businesses they visit and receive rewards from the businesses for their patronage. Collecting and analyzing customer information enables business proprietors to tailor business operations to better fit the needs and habits of customers and to provide rewards to customers based upon metrics determined by the proprietor. For instance, the business proprietor is enabled to offer rewards to loyal customers based upon the number of visits to the place of business within a certain time, the amount of purchases made, or the like. Providing business information to the customer enables the customer to retain contact, sales, offers, rewards, and other business-specific information, which tends to aid building of a relationship between the customer and the business. The system is simple, easy to use, and utilizes standard interfaces well known in the art, including the World Wide Web, to communicate between the three subsystems of the invention.

The invention is comprised of three subsystems: a Consumer Subsystem, a Business Subsystem, and a Central Subsystem. Each subsystem contains elements that interface with the other subsystems to provide the overall capability of two-way business-consumer information exchange and information organization. Preferably, the system is comprised of at least one Central Subsystem, a plurality of Consumer Subsystems, and a plurality of Business Subsystems.

The Consumer Subsystem enables the consumer to provide a selectable level of information to businesses of the consumer's choosing and to receive business information and rewards in return. The Consumer Subsystem is comprised of a Personal Information Device (PID) which is used to store customer personal data and business information and is carried by the consumer, a personal computer, and Consumer Application software residing on the personal computer. Consumer personal information and other business information are processed for the consumer by the application software of the invention residing on the consumer's personal computer. The Consumer Subsystem also enables the consumer to register with the system to obtain customer support and information, and to provide feedback on businesses participating in the system of the invention.

The Business Subsystem enables the business to exchange information with the consumer, and to provide rewards to particular consumers meeting certain defined criteria. The Business Subsystem is comprised of an Interface Electronics Unit (IEU), a Business Server, and Business Server Application software residing on the Business Server. The Business Subsystem provides information to the consumer, enabling the consumer to recall contact information, product information, reward information, and other information specific to the business. This provision of information to the customer is a unique and novel aspect of the invention, and works to build and enhance the consumer-business relationship. The Business Subsystem Business Server Application software organizes customer data into a database, enabling the business proprietor to analyze customer data and provide awards to customers based upon business-specific criteria as determined by the business proprietor. The Business Subsystem also, upon request, provides business metrics to the Central Subsystem enabling the business owner to analyze customer shopping habits, and further enables the business owner to review consumer feedback supplied by the customer online to the Central Subsystem. The Business Subsystem enables business proprietors to view and analyze customer information, shopping habits, shopping trends, times and dates of visits to the place of business, amount spent over a given period of time, and other information through an analysis of the data stored on the Business Subsystem database.

The Central Subsystem resides on hardware servers connected to the World Wide Web, and provides a World Wide Web interface to the system. The Central Subsystem is comprised of a set of software elements that provides an interface for the customer to utilize to register with the customer loyalty system. The Central Subsystem also allows the customer to view and update his own personal information stored on the database, and to view a listing of the businesses in a given geographical region that are users of the system. This feature of the invention enables the customer to select a specific business prior to making a business transaction, so that the customer may choose to do business with proprietors who are also users of the invention. In this manner, the system provides a benefit to the proprietor in that customers may be driven to his business because the customer understands that he will receive a personal benefit through the customer loyalty program. The information stored on the Central Subsystem database is preferably stored in an encrypted manner to provide a measure of security to the customer and business proprietor.

A first aspect of the invention is that the Information Exchange Unit of the Business Subsystem is portable and thus can be placed at a physical location within the customer's place of business such that it interfaces with the customer's personal information device at the point most convenient to do so. This aspect overcomes the disadvantage of POS loyalty systems that must be physically located near the point of sale, for instance at the cash register of a restaurant.

A second aspect of the invention is that it is may be used at any time during the customer's visit to the merchant's place of business, but preferably upon the customer's entrance to the business. It is not necessary that the invention be used only at the time a customer completes a transaction, as is required in POS customer loyalty systems. This overcomes the disadvantage of POS loyalty systems that require an actual sales transaction in order to achieve collection of data from the customer.

A third aspect of the invention is that it comprises readily available industry standard data interfaces including but not limited to serial bus interfaces such as the Universal Serial Bus (USB), magnetic card reader interfaces, Personal Digital Assistant (PDA) infrared interfaces, radio frequency communication interfaces such as the industry standard known as Bluetooth, optical bar code interfaces, and radio frequency tag interfaces.

A fourth aspect of the invention is that the reward achieved by the consumer is stored electronically within the Business Subsystem and may be automatically applied to the customer's bill or account at the time of award achievement, reducing the need for any printed coupons or the transmission thereof.

A fifth aspect of the invention is that the personal information device is small enough to be handheld so that it can easily be carried by the consumer.

A sixth aspect of the invention is that each business proprietor utilizing the system is enabled to structure a customer loyalty and reward program based upon criteria specific to the proprietor's business operation, and each business proprietor is enabled to perform analyses on the customer information stored on his Business Server. Thus, the system provides a significant advantage over customer loyalty systems of the prior art because it is configurable and tailorable to an individual business proprietor's needs.

A seventh aspect of the system is that a participating business is enabled to provide business-specific information to the consumer, and thus build and enhance the consumer-business relationship. This enhanced consumer-business relationship is beneficial to the business proprietor in that consumers who are provided information specific to a business may be more likely to return to the business, resulting in increased traffic and sales. The business information provided to the consumer includes but is not limited to contact information such as telephone number, address information, email address, fax number, and the like; sales and promotional information such as sales dates and special pricing; consumer reward information that is provided to the consumer based upon a specific consumer's metrics which include but are not limited to frequency of visits, amount of purchase, and the like; and other information determined by the business proprietor to be important in building and enhancing the consumer-business relationship.

### BRIEF DESCRIPTION OF THE SEVERAL VIEWS OF THE DRAWINGS

FIG. 1 depicts a system block diagram of the invention.

FIG. 2 depicts a block diagram of the Consumer Subsystem.

FIG. 3 depicts a block diagram of the Business Subsystem.

FIG. 4 depicts a block diagram of the Central Subsystem.

FIG. 5 depicts an embodiment of the communication between the Consumer Subsystem PID and the Business Subsystem.

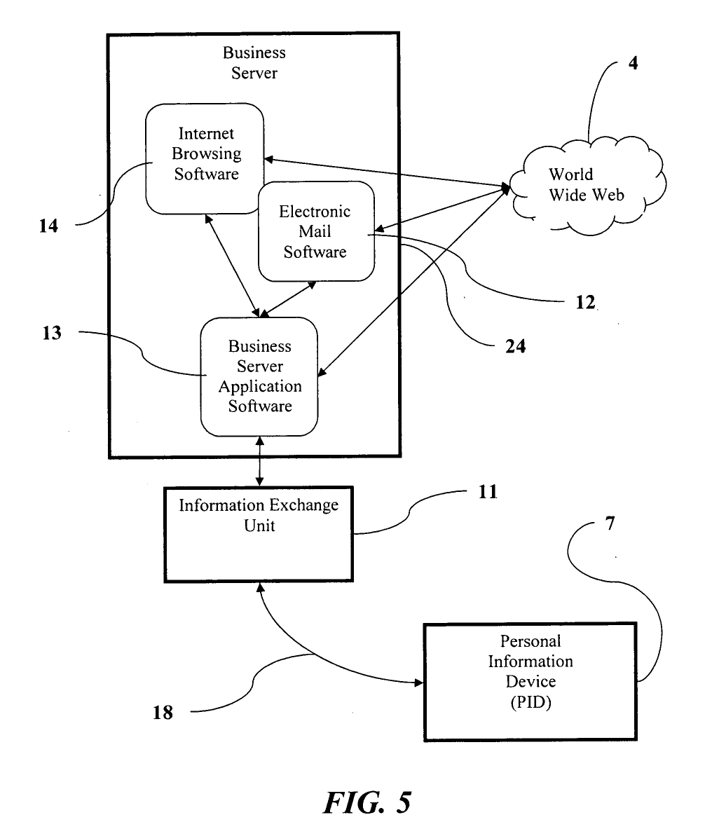

FIG. 6 depicts a preferred embodiment of the system utilizing a USB PID.

FIG. 7 depicts a PDA embodiment of the PID.

FIG. 8 depicts an example embodiment of the IEU of the Business Subsystem.

### DETAILED DESCRIPTION OF THE INVENTION

The invention is directed to a system, herein referred to as “the system”, including a method and apparatus for exchanging customer personal information with a business proprietor during a customer's visit to the proprietor's place of business, allowing the proprietor to analyze customer shopping and spending habits, perform general demographic analyses, reward customer loyalty, and perform other analyses beneficial to the proprietor for the purpose of tailoring business activities to effectively address and reward the proprietor's market. The customer receives information about the business at a level determined by the business proprietor (for example, address, phone, web address, email, menu, and hours of operation). The system is applicable to any business establishment including but not limited to retail stores, restaurants, wholesale establishments, theme parks, theatres, sports stadiums, service providers, and any other business establishment which serves customers by providing goods, services, or entertainment.

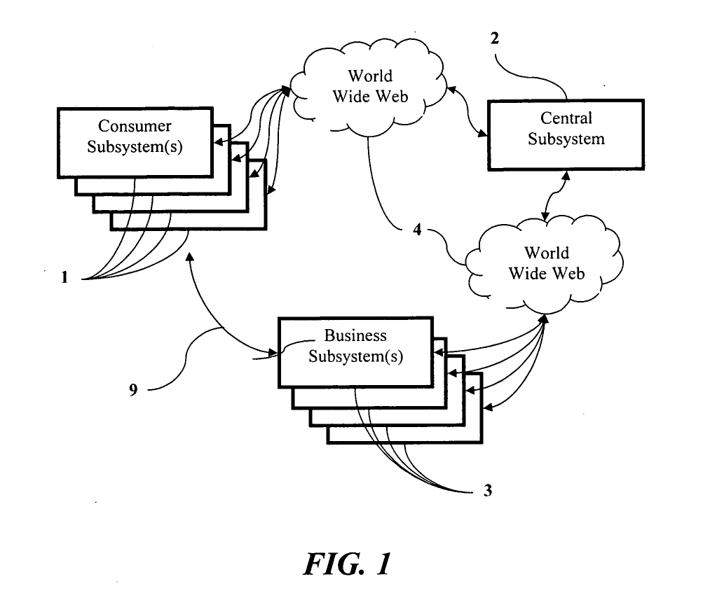

Referring to FIG. 1, the invention is composed of at least one each of three subsystems: the Consumer Subsystem 1, the Business Subsystem 3, and the Central Subsystem 2. Preferably, the system is further comprised of a plurality of Consumer Subsystems and a plurality of Business Subsystems, each of which may be unlimited in number. Each subsystem is comprised of either hardware elements, software elements, or both, which communicate with the other subsystems of the invention to provide the capability of customer data collection, retention, organization, analysis, and generation and delivery of rewards to the customer. Preferably, customer and business data are retained on databases in a secure manner and any internet transmission of said data utilizes World Wide Web transmission protocols and data encryption methods that are well known in the art.

The Consumer Subsystem 1 enables the consumer to provide a selectable level of information to businesses of the consumer's choosing and to receive business information and rewards in return. The Consumer Subsystem 1 allows the consumer to collect, manage, and store information regarding the location and contact information of businesses utilizing the system. The Consumer Subsystem 1 also enables the consumer to register as a user of the system. A consumer utilizes the Consumer Subsystem to obtain customer support and information, and to provide feedback on businesses utilizing the invention by communicating customer feedback to the Central Subsystem.

The Business Subsystem 3 enables the business to exchange information with the consumer, and to provide rewards to particular consumers meeting certain defined criteria. A Business Subsystem software application organizes customer data and performs analyses on the customer information in order to reward customer loyalty for those customers meeting criteria as defined by the business proprietor. The Business Subsystem also, upon request, provides specific metrics to the Central Subsystem and enables the business owner, or proprietor, to review consumer feedback and comments regarding his business operation.

The Central Subsystem 2 provides a World Wide Web interface utilized by customers for registering with the system. The World Wide Web interface is also utilized by businesses for the exchange of information between the Business Subsystem and the Central Subsystem. The Central Subsystem also contains web server application software that obtains metric information from the Business Subsystem and stores that information in a loss-safe database.

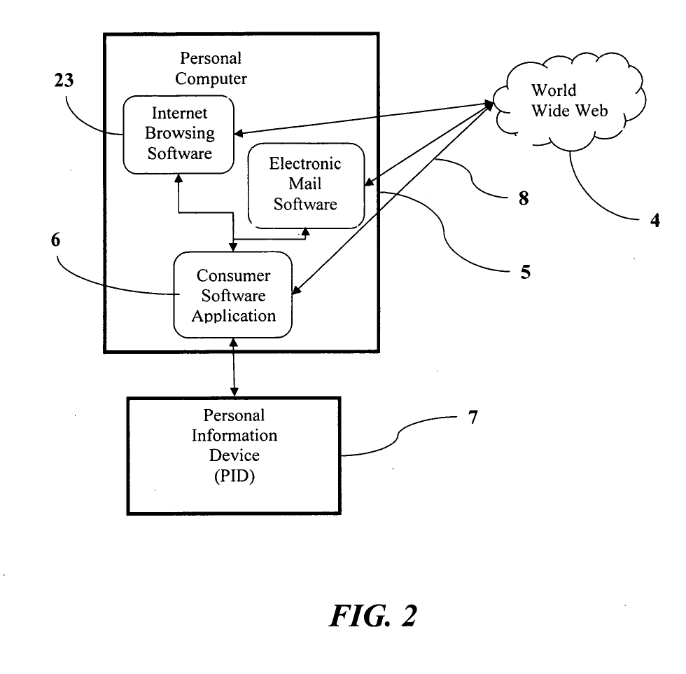

Referring to FIG. 2, the Consumer Subsystem 1 comprises a consumer personal computer 5 having an internet World Wide Web connection 8, and a Consumer Software Application 6. The Consumer Subsystem is used by a consumer to register with the system by entering information into the Personal Computer 5 utilizing the Consumer Software Application 6. The Consumer Software Application 6 then communicates the consumer personal information to the Central Subsystem utilizing the World Wide Web connection 8. The Consumer Software Application 6 further enables a consumer to view and modify his personal information stored on the Central Subsystem, and to view information communicated to the Consumer Subsystem from the Central Subsystem, through the World Wide Web connection 8. The Personal Computer of the Consumer Subsystem is further comprised of internet browsing software 23 which is well known in the art and electronic mailing software 22 which is well known in the art. The Consumer Subsystem is further comprised of one or more Personal Information Devices (PIDs) 7 having a memory for storing information and a communication means, said PID selected from the group consisting of a Personal Digital Assistant (PDA), which further comprises a consumer PDA mobile software application specific to the invention (the PDA mobile application software) and an infrared communications means; a PDA which further comprises a consumer PDA mobile software application specific to the invention (the PDA mobile application software) and a radio frequency communications menas utilizing a standardized communication protocol and hardware layer which are well known in the art, for example Bluetooth; a PDA cellular telephone, which further comprises a consumer PDA mobile software application specific to the invention (the PDA cell phone mobile application software) and an infrared communication means which is well known in the art; a portable solid state memory device commonly known as a USB thumb drive having a standard serial data bus communication means of the type known as a Universal Serial Bus (USB) interface, which is commonly used to store and carry data between computers; a Radio Frequency (RF) tag device well known in the art having an RF communications means; an optical bar coded card having an optical bar code communications means; a magnetic proximity card having a magnetic communications means; and a magnetic swipe card having a magnetic swipe communications means similar to the standard magnetic credit card which is well known in the art. The PID typically remains in the possession of the consumer.

A preferred embodiment of the PDA PID is one wherein the PDA is comprised of a standard infrared communications means for both receiving and transmitting information. Such PDA infrared interface ports are well known in the art.

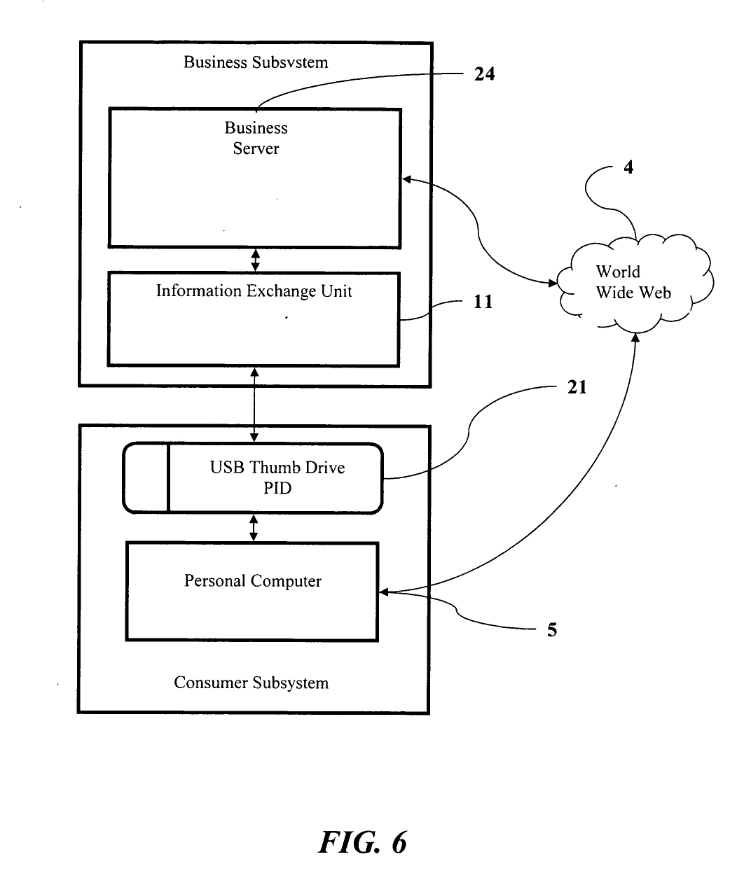

Referring to FIG. 6 of the drawings, a preferred embodiment of the solid state memory device PID is shown, wherein the PID is configured to be small, portable, transferable from computer to computer, and interfaces electronically with a standard personal computer interface such as the USB interface which is well known in the art. Such USB solid state memory devices are well known in the computing art and are commonly known as USB thumb drives. FIG. 6 depicts USB thumb drive PID 21 communicating with the personal computer 5 of the Consumer Subsystem, and communicating with the IEU 11 of the Business Subsystem. In use, the customer carries USB thumb drive PID 21 upon his person, and when entering business that participates in the system of the invention, the customer inserts USB thumb drive PID 21 into the receiving USB port of the IEU 11, preferably upon entry to the place of business. Communication between USB thumb drive PID 21 and the IEU 11 occurs, allowing the Business Subsystem to update the relational database residing thereon with information from the PID 21. The IEU 11 may also transmit information to the USB thumb drive PID 21 as pre-determined by the business proprietor. Upon returning home from the place of business, the consumer may then insert USB thumb drive PID 21 into a USB serial interface port of Personal Computer 5 of Consumer Subsystem 1, allowing the transfer of information received by PID 21 from IEU 11 to Personal Computer 5 of Consumer Subsystem 1.

An embodiment of the RF tag PID is that wherein the RF tag is adapted to be carried on a set of keys for ease of portability. Another alternate embodiment of the RF tag PID is that wherein the RF tag is placed within a plastic card adapted to fit within the consumer's wallet. Other alternate embodiments exist which are equivalent in the art to the embodiments described herein and do not depart from the spirit or gist of the invention. In use, the consumer carries the RF tag PID on his person, and upon entry of the place of business, the RF tag interface of the IEU recognizes the presence of the consumer's RF tag, reads the information stored on the consumer's RF tag, and communicates the information read from the consumer's RF tag to the Business Server Application Software 13 of the Business Server 24 for further processing by the Business Server Application Software 13.

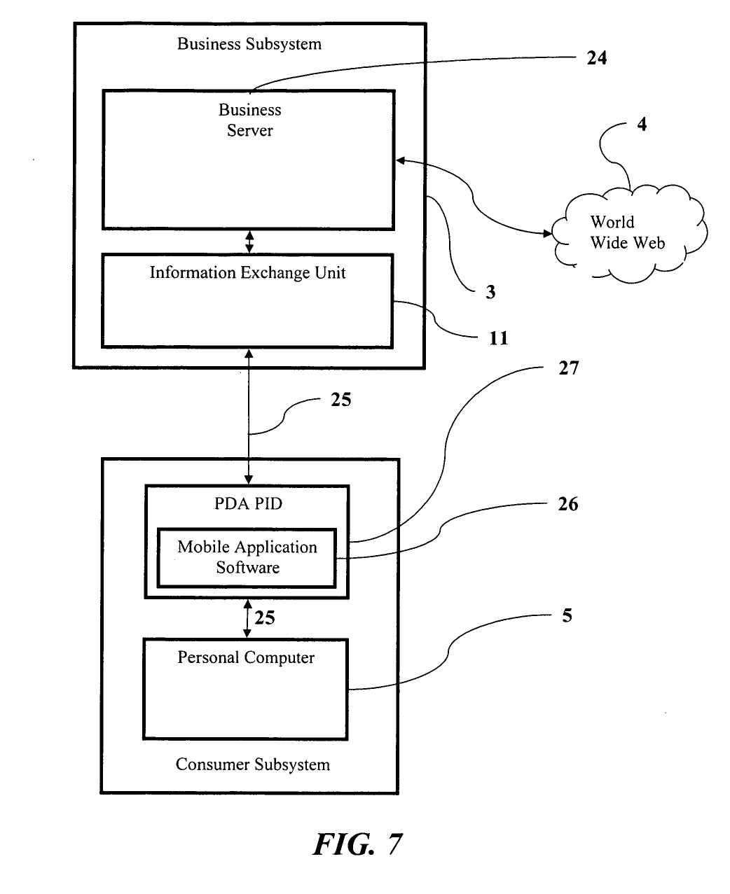

Referring to FIG. 7, the PDA embodiment of the PID 27 is comprised of a PDA, which is well known in the art, having Mobile Application Software 26 residing thereon which is specific to the invention. The Mobile Application Software 26 operates to store consumer personal information on the PDA PID 27, and also operates to manage communication between the PDA PID and the Personal Computer 5 of the Consumer Subsystem 1 and the IEU 11 of the Business Subsystem 3. The PDA PID 27 communicates with the Consumer Application Software 6 residing on the consumer Personal Computer 5 utilizing a standard PDA interface means which is well known in the art. The PDA PID 27 may communicate with the Consumer Application Software 6 residing on the consumer Personal Computer 5 utilizing the standard PDA synchronization techniques well known in the art which are used to synchronize data and software applications on the PDA with information and applications residing on the personal computer. Such synchronization techniques commonly utilize a standard interface 25 which may be a USB port interface, a radio frequency data transmission interface well known in the art such as Bluetooth, a standard infrared interface, or a standard serial interface on a personal computer. Such PDA synchronization interfaces are well known in the art. The PDA Mobile Application Software 26 residing in the PDA communicates with the Consumer Application Software 6 residing on the consumer Personal Computer 5 and enables the transmission of data and application updates between these two applications. The PDA PID communicates with the IEU 11 using communication means 9 selected from the group consisting of infrared data transmission and radio frequency data transmission, for instance, Bluetooth. In use, the customer carries PDA PID 27 upon his person, and when entering business that participates in the system of the invention, the customer initiates communication between PDA PID 27 and IEU 11, preferably upon entry to the place of business, by initiating either infrared or radio frequency data transmission from PDA PID 27. Communication between PDA PID 27 and IEU 11 occurs, allowing the Business Subsystem to update the relational database residing thereon with information from PDA PID 27. The IEU 11 may also transmit information to PDA PID 27 as pre-determined by the business proprietor. Upon returning home from the place of business, the consumer may then synchronize PDA PID 27 with the Personal Computer 5 of the Consumer Subsystem 1, allowing the transfer of information received by the PID 21 from the IEU 11 to the Personal Computer 5 of the Consumer Subsystem 1. Alternatively, the consumer may simply initiate infrared or radio frequency data transmission between PDA PID 27 and the Personal Computer 5 of the Consumer Subsystem to transfer the business information to Personal Computer 5.

In all cases wherein the PID is comprised of a read/write memory, for example the PDA PID or the USB thumb drive PID, the Consumer Application Software 6 residing on the consumer Personal Computer reads files from, and writes files to, the PID in accordance with a format specifically designed for the application of the invention.

When using the USB thumb drive embodiment of the PID, the Consumer Software Application 6 communicates with the Central Subsystem 2 via the World Wide Web 4, and the Consumer Software Application 6 writes the consumer personal information to the memory of the USB PID 21 while the USB PID remains inserted in the receiving USB port of the Personal Computer 5 of the Consumer Subsystem. The consumer then removes the USB PID and carries it upon his person. Upon entry into a place of business that utilizes the customer loyalty system of the invention, the consumer inserts the USB PID 21 into a USB receiving port of the IEU 11 of the Business Subsystem 3. Upon insertion of the USB PID 21, the IEU reads information and communicates this information to the Business Server Application Software 13 residing on the Business Server 24 of the Business Subsystem.

In a preferred embodiment of the invention, some or all of the information stored on the PID is protected by encryption means, and only data of the correct form will be read and utilized by the system. In this manner, the system of the invention is protected from accidentally reading information from a PID which is not meant to be utilized by the system. A further alternate embodiment of the PID includes one or a plurality of special fields that indicate that the data residing upon the PID is valid. If the data on the PID is encrypted, the IEU decrypts the data; and if the decryption operation fails, the data is invalid, or the invalid data field is not set correctly, the IEU will report an error and no business information is provided to the consumer.

The customer information stored on the PID is termed “customer indicia”. Customer indicia includes but is not limited to information specific to the customer and which may be comprised of one or any combination of the following types of information: customer name, address, telephone, email address, age, household statistics, marital status, number of children, ages of household occupants, household income, individual income, other contact information, customer preferences, a specific customer number assigned by the system, media identifier which indicates information identifying the type of PID, and other specific customer information as determined by either the business proprietor, the customer, or both of them. The invention is not limited by the amount or types of information stored on the PID. It is an aspect of the invention that the information stored on the PID is tailored as determined by each individual business proprietor participating in the system of the invention, and also by each customer participating in the system of the invention. This attribute of customization, which enables a single system of the invention to meet the specific customer information collection and reward program needs of a plurality of differing businesses, is a significant advantage over the state of the art of customer reward and loyalty systems.

An alternate embodiment of the system of the invention is one wherein a plurality of discrete levels of participation by the customer are defined. One specific embodiment of the system is on wherein three discrete levels of participation by the customer are defined as a first level of participation, a second level of participation, and a third level of participation. In said first level of participation, the customer provides information comprising name, contact, and age information to the system of the invention. In said second level of participation, the customer provides information comprising the information of the first level, information regarding hobbies, and information regarding preferences. In said third level of participation, the customer provides information comprising the information of the first level, the information of the second level, demographic information, income information, marital status information, and information regarding the number of children in the household.

The customer indicia are stored on the PID in either a secure format or a non-secure format. A preferred embodiment of the secured format is that wherein the indicia are generated by the system in either the Central Subsystem or the Consumer Subsystem, are encrypted by the subsystem that generated the indicia, and are then stored on the PID by any of the communication means described herein. The secure method of storing customer indicia on the PID is preferred in order to protect the personal information of the customer and reduce business proprietor liability for lost or stolen information that may be personal to the customer.

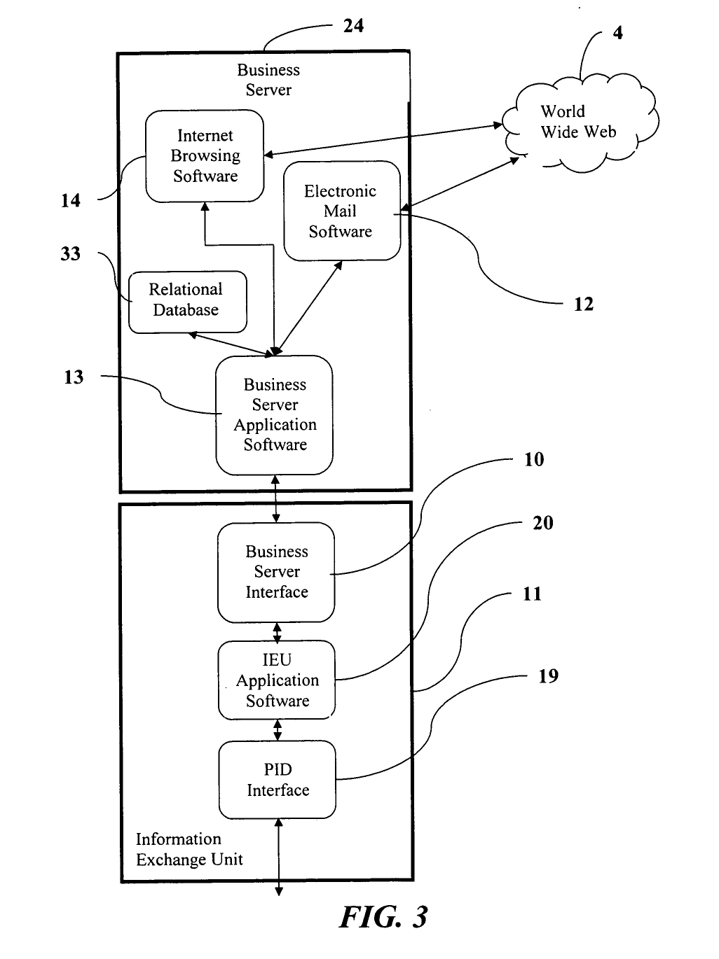

Referring to FIG. 3, the Business Subsystem 3 comprises an Information Exchange Unit (IEU) 11 specific to the invention and a Business Server 24 comprising a personal computer well known in the art with the following software residing thereon: Business Server Application Software 13 specific to the invention, internet browsing software 14 which is well known in the art, and electronic mailing software 12 which is well known in the art. The Business Subsystem is utilized by the business proprietor.

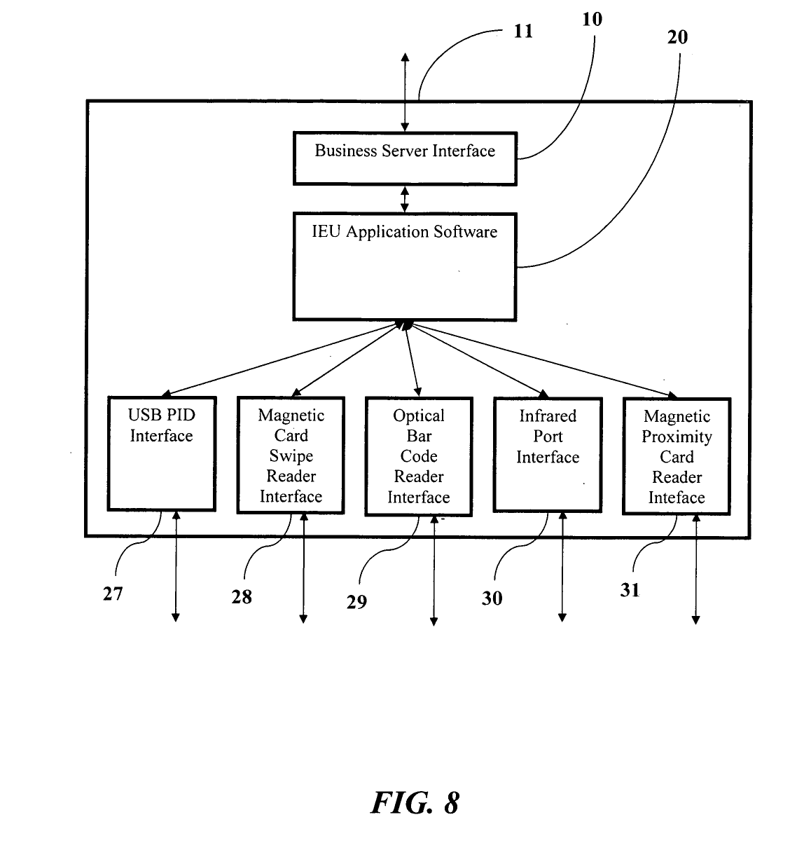

The IEU 11 of the Business Subsystem comprises a computer having at least one business server interface 10 selected from the group consisting of a radio communications port of the type commonly used in personal computers such as that defined in Institute of Electrical and Electronic Engineers (IEEE) specification 802.11 commonly known as WiFi, an Ethernet interface port, a standard computer serial interface port, a standard computer parallel port, or a USB interface port. The IEU 11 is further comprised of one or more PID interfaces 19 selected from the group consisting of a standard magnetic card reader, at USB interface, a radio communications port of the type commonly used in personal computers such as that commonly known as Bluetooth, an optical bar code reader, a magnetic proximity reader interface, a radio frequency tag communications interface, or an infrared communications port. The IEU is further comprised of IEU Application Software 20 specific to the invention which is in communication with the PID interface of the IEU 19 and with the Business Server Interface 10 of the IEU. The IEU may have any number of PID interfaces of any of the types disclosed above, in any combination. The invention is not limited by the specific number or types of PID interfaces included in the IEU. An example embodiment of the IEU 11 is shown in FIG. 8, in which the IEU 11 includes a USB PID interface 27, a magnetic card swipe reader interface 28, an optical bar code reader interface 29, an infrared interface 30, and a magnetic proximity card reader 31. Further alternate embodiments of the IEU 11 may include additional PDA PID interfaces of any of the type described herein.

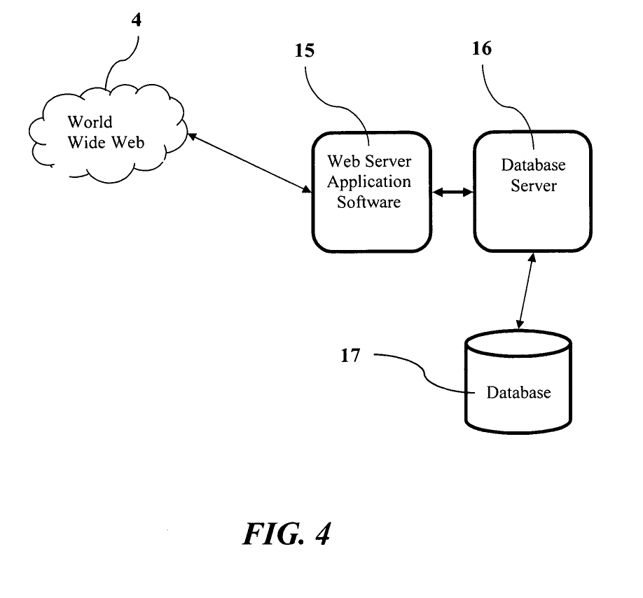

Referring to FIG. 4, the Central Subsystem 2 is a combination of software elements comprising a Central Subsystem Web Server Application Software 15 specific to the invention, Central Subsystem Database Server Software 16 specific to the invention, a Database 17 comprising consumer and merchant information. The combination of software elements comprising the Central Subsystem may reside on a single web server host computer or may be distributed across a plurality of web server host computers. The Web Server Application Software 15 is preferably in communication with the Consumer Subsystems 1 via the World Wide Web 4, and is in communication with the Business Subsystems 3 via the World Wide Web 4.

The Consumer Subsystem 1 is preferably in communication with Central Subsystem 2 through the internet World Wide Web connection of the consumer subsystem personal computer. This World Wide Web interface is of the type which is well known in the art. The internet web browser software 23 resident on the consumer Personal Computer 5 of the Consumer Subsystem 1 accesses the World Wide Web 4 utilizing techniques that are well known in the art. The consumer software application 6 of the Consumer Subsystem 1 communicates with the Web Server Application Software 15 of the Central Subsystem 2 via the World Wide Web using the web browser software 23 resident on the Personal Computer 5 of the Consumer Subsystem 1.

Alternatively, for those consumers who do not own or do not know how to use a personal computer, the Consumer subsystem may comprise simply a PID, without any personal computer. In this embodiment of the consumer subsystem, the customer information must be entered into the system by other means such as the business proprietor utilizing a computer with access to the World Wide Web, by manually entering the customer personal information into the system. This alternative embodiment requires that the customer be issued a PID in order to use the system. This alternate embodiment of the invention, in which the Consumer Subsystem does not include a Personal Computer 5, preferably utilizes a magnetic card PID.

The Consumer Subsystem 1 communicates with the Business Subsystem 3 when the consumer utilizes a PID 7 to communicate with the Information Exchange Unit 11 of the Business Subsystem. To achieve this communication, the consumer interfaces the PID 7 with the appropriate PID interface of the IEU. For instance, in the case wherein the consumer utilizes a PDA PID having an infrared interface, the consumer points the PDA PID infrared port at the infrared PID interface of the IEU and initiates communication. In the case where the consumer utilizes a PDA PID with a radio frequency interface, the consumer presents the PDA PID 7 in proximity to the IEU 11 and initiates radio frequency communication. In the case where the consumer utilizes a solid state memory PID with a USB interface, also known as a thumb drive, the consumer inserts the thumb drive PID into the USB receiving port of the IEU 11. The IEU Application Software 20 recognizes the USB PID and initiates communication. Likewise, in the case wherein the user utilizes a magnetic card PID, the consumer swipes the card through the magnetic card reader PID interface of the IEU 11. Upon the swipe of the card, the IEU application software 20 recognizes the data input and accepts the data stored on the card and read by the card reader. In all cases, the IEU Application Software 20 receives consumer data from the PID 7, checks to verify that the consumer data is in the correct format of the system, reads the consumer data, decrypts the consumer data if necessary, stores the consumer data, and communicates the consumer data to the business server. The IEU Application Software 20 checks the data format and only data of the correct form will elicit a response from the IEU 11. The IEU 11 decrypts the data if the data is encrypted, and checks the special valid-data field. If the decryption fails, the data is invalid, or the invalid data field is not set correctly, the IEU 11 will report an error and no business information is provided to the consumer. On successful read of consumer data, the IEU 11 communicates the customer data to the Business Server 24 utilizing the communication means of the Business Server Interface 10 which is shown in FIG. 3, which may be a hardwire standard electrical interface such as Ethernet, a standard serial computer interface, a USB interface, a wireless interface such as the standard known as WiFi, or a standard computer parallel interface; or the data may be communicated by storing on portable media such as a USB thumb drive, floppy disk, or optical disk, which is then physically carried to the Business Server 24 where it is read by the appropriate media interface port. In the case where the consumer data is stored on portable media, the Business Server 24 may be located anywhere at all, for instance at the proprietor's remote office or home. In this manner the IEU 11 may be the only hardware element of the system to reside at the physical place of business. This particular embodiment of the invention overcomes the difficulty encountered by some business proprietors who do not have a computer on the business premises that can operate as a Business Server 24, or who wish to place the IEU 11 remotely from the Business Server 24 due to the nature or physical setup of their business operation. This may be desirable, for instance, for businesses whose immediate physical environment may not be suitable for the placement of personal computers. One example of such a business is a car wash. IEU 11 also communicates business information to the PID in those circumstances wherein the PID is of the type that can receive and store such information, such as the PDA PID and the USB thumb drive PID.

For those PIDs that are not capable of immediately receiving and storing the business information (magnetic storage, etc.), the Business Server Application Software 13 running on the Business Server 24 in the Business Subsystem 3 will, based on the media-type field in the data retrieved from the PID, email the business information to the consumer utilizing electronic mail techniques well known in the art.

The first step in utilizing the system of the invention is to perform an initial load of customer personal information into the PID 7. Customer personal information preferably is first entered into the system by the consumer, utilizing the Personal Computer 5 of the Consumer Subsystem 1 to communicate with the Web Server Application 15 of the Central Subsystem 2 via the World Wide Web 4. The consumer personal information transmitted to the Web Server Application 15 includes but is not limited to geographic, demographic, financial, contact, household, and other information. Examples of typical consumer information-provided to the Web Server Application 15 by the consumer are name, address, telephone number, customer identification number, email address, age, gender, household income, number of persons in the household, product preferences, store and merchant preferences, amount spent on various categories of goods and services, and other information related to the personal spending habits of the consumer. Alternatively, the customer may fill out a paper form providing the personal information, and the business proprietor, or one of his employees, may enter this information for the customer by entering the information on a computer communicating with the Web Server Application 15 via the World Wide Web 4. A yet further alternative method for providing the consumer personal information to the Web Server Application 15 is the filling out of a paper form by the consumer and mailing the form to a receiving entity who provides the consumer personal information to the Web Server Application 15 by entering on a computer communicating with the Web Server Application 15 via the World Wide Web 4. These two alternate methods may be beneficial for those consumers who wish to participate in the customer loyalty system of the invention, but who do not own a personal computer, or who are not skilled at using a personal computer.

Once the consumer personal information is loaded into the system by the user, the Web Server Application Software 15 processes and stores the data on the Database 17 of the Central Subsystem 2 for later retrieval and use by the merchant. The consumer personal information stored on the Database 17 of the Central Subsystem 2 may also later be retrieved and modified by the consumer.

Next the PID 7 is initialized for use by the consumer. This step is comprised of generating a specific alphanumeric customer identifier, selectively encrypting the alphanumeric identifier along with selected personal information, formatting the alphanumeric identifier and selected personal information into a format specific to the invention, and loading the formatted and encrypted alphanumeric identifier and selected personal information onto PID 7. This consumer-specific information is the consumer indicia. These steps are performed by the Web Server Application Software 15 of the Central Subsystem 2. In the case where the PID is a PDA, the Web Server Application Software 15 generates a file containing the consumer indicia for download to the PDA PID and communicates the file to the Personal Computer 5 of the Consumer Subsystem 1 for delivery to the PDA PID upon the next synchronization of the PDA PID. In the case were the PID is a magnetic card, the Web Server Application Software 15 communicates the consumer indicia to a magnetic card writer which is well known in the art. The consumer indicia are then written to a magnetic card which is delivered to the consumer for use. In the case where the PID is a radio frequency tag, the Web Server Application Software 15 communicates the consumer indicia to a radio frequency tag writer which writes the consumer indicia to a radio frequency tag utilizing equipment and techniques well known in the art, and the tag is delivered to consumer for use. In the case where the PID is a solid state memory device such as USB thumb drive, the consumer indicia is communicated by the Web Server Application Software 15 to the Personal Computer 5 of the Consumer Subsystem 1 via the World Wide Web 4. The Consumer Software Application 6 of the Consumer Subsystem 1 then writes the information to the memory of the USB PID via a USB port of the Personal Computer 5 utilizing standard techniques for writing files to a memory device.

Once the consumer indicia has been loaded into the database of the Central Subsystem 2 and a PID 7 has been initialized by one of the aforementioned techniques, the consumer is able to enter a place of business and utilize the invention. Upon entry to a merchant's place of business, the consumer presents the PID 7 to the IEU 11 of the Business Subsystem 2 by the appropriate method dependent upon the type of PID used by the consumer. For instance, in the case of the PDA PID having an infrared port, the consumer points the PDA at the infrared interface of the IEU 11 and initiates communication. For the case where the PID is a magnetic card, the user swipes the card through the magnetic card reader of the IEU 11. In the case where the PID is a PDA having a radio frequency interface such as Bluetooth, the user initiates Bluetooth communication utilizing the standard commands of the PDA. In the case where the PID is a radio frequency tag, the consumer simply presents the tag in proximity to the tag reader of the IEU 11. In the case where the PID is a solid state memory device such as a USB thumb drive, the consumer inserts the memory device PID into the interface designed to receive it, for instance a USB port, on the IEU 11 of the Business Subsystem 2. The IEU 11 then reads the customer indicia stored on the PID, and presents the data in the customer indicia file to the IEU Application Software 20 for processing. In all these cases, the IEU Application Software 20 checks the data format and only data of the correct form will elicit a response from the IEU. The IEU 11 decrypts the data and checks the special valid-data field. If the decryption fails, the data is invalid, or the invalid data field is not set correctly, then the IEU 11 will report an error and no business information is provided to the consumer. Once the consumer indicia is validated as specific to the invention, it is communicated to the Business Server Application Software 13 residing on the Business Server 24 by the IEU Application Software 20 through the Business Server Interface 32. That data is stored in a small optimized relational database located on the Business Server 24.

Next, the Business Subsystem communicates business-specific information to the consumer. This is accomplished by various means depending upon the type of PID utilized by the consumer. For consumers utilizing a PDA or USB thumb drive PID, the business-specific information is written to the memory of the PID utilizing the communication means of the PID. For instance, a consumer utilizing a PDA PID with an infrared communication interface will receive business-specific information transmitted from the IEU 11 of the Business Subsystem via infrared communication. Consumers utilizing a PDA PID having an RF interface such as Bluetooth will receive business-specific information via the RF interface. Consumers utilizing a USB thumb drive PID will receive business-specific information via the USB communication port of the IEU 11. Consumers utilizing optical bar code, magnetic swipe, magnetic proximity, or other PID types without the ability to receive data from the IEU 11 receive business information via email or via the World Wide Web. For these applications, the Business Subsystem provides business information to the consumer by emailing the consumer directly. Alternatively, the Business Subsystem may communicate the business information to the Central Subsystem 2 via the World Wide Web 4, whereupon the Central Subsystem Web Server Application Software 15 updates a web page with the information from the Business Subsystem that is specific to the consumer. The web page is specific to a consumer and may be protected by the use of a username and password specific to the consumer. The consumer may then access the web page via the World Wide Web 4 from any computer, type in his specific username and password, and view his specific data which may include business address information, reward status, indicators displaying how close the consumer is to achieving a reward status, history of purchases made, and the like. The information displayed to the consumer in this manner is not limited to the afore-mentioned information. Furthermore, the method chosen to communicate with the consumer may be redundant; for instance, a consumer utilizing a PID with memory capability may receive business information from the IEU at the time of visiting the customer premises as indicated above, and the business information may also be transmitted to the Central Subsystem for displaying in a web page personal to the consumer as mentioned above. A further additional means of communicating business specific information is for the Business Subsystem to communicate this information to the consumer via email. Email communication of business information may be utilized regardless of the type of PID utilized by the consumer. A further additional means of communicating business information to the consumer is for the Central Subsystem to implement a web-based email function such that a consumer is assigned a web based email mailbox managed by the Web Server Application Software 15. For this case, the consumer accesses his specific mailbox via the World Wide Web 4, views his email inbox, and is thus able to view email from the Business Subsystem communication business specific information.

The reward system of the invention may be utilized without any communication from the Business Subsystem to the consumer. Although this is not a preferred embodiment of the system, a reward system operating in such a manner would simply generate customer rewards by analyzing the consumer data stored in the Business Subsystem, and provide notification to the consumer at the time of purchase, for instance when the consumer approaches the point of sale.

Once the consumer information has been read from the PID 7 and communicated to the Business Server 24, the business proprietor can access the consumer data stored in the optimized relational database 33 that supports showing the data as sorted in a variety of ways useful to the business proprietor. The default display option is to show the data sorted by type of retailer and location. The business proprietor can utilize the information stored in the relational database 33 of the Business Subsystem to generate and send rewards and information to specific consumer individually, or groups of consumers, based upon the business proprietor's grouping of consumers. Consumers can be grouped in accordance with the desire of the business proprietor utilizing the information stored on the relational database 33 of the Business Subsystem 2. Certain metrics, preferably comprised of customer visit counts, are communicated by the Business Server 24 to the Central Subsystem Web Server Application 15 via the World Wide Web 4. In a preferred embodiment of the invention all information transmitted via the World Wide Web 4 is communicated utilizing standard well-known techniques for transmitting data in a secure fashion over the World Wide Web, such as the https protocol which is well known in the art. The Web Server Application Software 15 communicates with the Database Server Software 16, causing the metrics to be stored into the Database 17 of the Central Subsystem 2. The metrics communicated from the Business Server 24 of the Business Subsystem 2 to the Web Server Application Software 15 for storage onto the Database 17 of the Central Subsystem 2 may include purchase information, customer indicia in whole or in part, and customer visit counts.

At any time, the merchant may utilize the Business Server 24 to access the relational database 33 of the Business Subsystem 3 by utilizing the Business Server Application Software 13. The Business Server Application Software 13 retrieves data and formats reports at the command of the business proprietor. In this manner shopping habits, demographic and geographic analysis, amount of purchases made by grouping of customer, and other data analysis may be performed by the business proprietor. The business proprietor may select rewards for consumers based upon parameters specific to his business: for instance, the business proprietor may choose to reward customers based upon the number of trips to the place of business, the amount of purchases over a certain time, by customer birth date, or any other metric or set of metrics based upon information stored in the database. The invention is not limited by the number of specific metrics or types of information the business proprietor chooses to collect, nor is the invention limited by a specific number or types of information utilized by the business proprietor to determine customer rewards. It is a feature of the invention that each business proprietor selects the information he collects, and each proprietor selects the specific award criteria relative to his specific business. The flexibility of the invention which allows each business proprietor to tailor the use of the invention to his specific business operation is a significant advancement over the state of the art.

Customer rewards are stored electronically on the Business Server 24 of the Business Subsystem 3 and do not typically require any form of paper coupons to be mailed to the consumer. Consumers are typically notified of their reward electronically; for instance through electronic mail. Customer notification via email is typically performed by the Business Server 24 of the Business Subsystem 3. This approach for communicating customer rewards reduces the costs associated with mailing of paper coupons, and furthermore reduces the need for the customer to store and maintain unnecessary paper. The ease of use of the system in providing for the automatic awarding of rewards, electronic mail notification to the customer, elimination of paperwork, and use of the World Wide Web allowing the customer to review lists of businesses participating in the invention and to review the status of their personal awards are features of the invention that are significant advancements in the state of the art.

At any time the consumer may access the Web Server Application Software 15 over the World Wide Web 4 by utilizing the web browser software on the Consumer Subsystem Personal Computer 5. The consumer may wish to do this in order to update his personal information in the system. The consumer may also wish to enter quality survey information into the database in order to provide feedback regarding the merchant's performance, quality of goods and services, and the like for a specific business proprietor. The business proprietor is able to access consumer feedback information by communicating with the Web Server Application Software 15 to query the Database 17 of the Central Subsystem 2 for consumer feedback information relative to his business operation. In this manner the merchant is able to gain an understanding as to how the quality of his business operations are viewed by his customers.

The disadvantages of the prior art are overcome by the various embodiments of the present invention. By allowing the personal information to be transmitted to the IEU upon entry to the place of business, the invention allows a customer visit to be recorded even though no purchase has been made, the information is easily and quickly exchanged, the consumer is provided information about the business, and the merchant is provided an accurate set of data from which he can better analyze the shopping habits of his customers. This aspect of the invention eliminate the need for a specific point of sale within the merchant's place of business and enables a more accurate data base because all customer visits to the place of business can be recorded, not just visits that culminate in a purchase of goods or services.

Business proprietors realize cost savings through reduced advertising costs, making reaching a wider target market possible even with the limited advertising budgets normally found in small to medium businesses. Furthermore, since the customer loyalty and reward program is configurable by each business proprietor, the system of the invention is usable for the small to medium sized business which do not have the assets, resources, or time to develop their own reward system. The system of the current invention is therefore usable by such businesses. The system of the invention also provides an advantage to the business proprietor in that while the reward system is in use, the business proprietor has the ability to analyze customer visit and personal information stored on the Business Server 24 of the Business Subsystem 3, enabling the business owner to develop a better view of the demographic, geographic, and other metric information related to his particular customer and market base. Such information is valuable for aiding in decision making; for instance, where, when, and how to spend advertising funds. These decisions can be critical for the success of such businesses. A business proprietor who subscribes to the system of the current invention is therefore at an advantage over his competitors who do not utilize the system of the invention.

Another aspect and advantage of the system is that the consumer is able to deliver quality survey and report information via the World Wide Web interface of the personal computer of the Consumer Subsystem to the web server application. This quality survey information is stored in the database and may be used by the business proprietor to gain a better understanding of the way his customers view his business operation.

Another aspect and advantage of the invention is that a consumer is enabled to review a directory of places of business participating in the system of the invention in a given geographic area. The customer accesses this data over the World Wide Web by utilizing the web browser software of his personal computer to access the Web Server Application Software, which interrogates the database and provides a response to the consumer indicating the identification of businesses participating in the system of the invention that meet a certain criteria such as geographic or price criteria. The customer is thus able to review a list of participating businesses. The system of the invention is therefore useful to encourage patronage of participating businesses.

Another aspect and advantage of the invention is that it is easily utilized to provide a wide range of reports based upon demographic, shopping pattern and habits, geographic, and other data, thus enabling the merchant to fine-tune his business operations to be better tailored to his patrons. The system supports both “hard” rewards (for example, discounts and the like) and “soft” rewards (for example, preferred seating and the like). The system also builds customer loyalty through the accumulation of customer rewards, the value of which may increase as the consumer continues to spend more time and money at a particular business.

While specific embodiments of the invention are described herein, it is immediately obvious to one skilled in the art that many equivalent embodiments are conceivable without departing from the gist and spirit of the invention.

1. A system for rewarding customer loyalty and providing business information to a consumer, comprising:
a consumer subsystem in communication with the World Wide Web comprising a personal information device and a consumer personal computer having a consumer software application, wherein the personal information device is comprised of at least a memory storage means for storing customer indicia and storing at least customer indicia, and wherein the personal information device is in communication with said consumer personal computer by a first communication means;
a central subsystem in communication with the World Wide Web comprising a web server software application in communication with a database server software application, wherein said database server software application is in communication with a database;
a business subsystem in communication with the World Wide Web comprising an information exchange unit and a business server having a business server software application in communication with a relational database; wherein said information exchange unit is in communication with said personal information device by a second communication means, and wherein said information exchange unit is in communication with said business server by a third communication means selected from the group consisting of a serial computer interface, a parallel computer interface, a Universal Serial Bus computer interface, a radio frequency computer interface, removable portable magnetic media, removable portable solid state memory media, and a Universal Serial Bus removable portable thumb drive;
wherein said information exchange unit receives said customer indicia stored on said personal information device by said second communication means, and wherein said information exchange unit communicates customer indicia to said business server software application, and wherein said business server software application stores said customer indicia on said relational database, and wherein said business subsystem communicates business information to a consumer by a fourth communication means.

2. The system of claim 1, wherein said personal information device is selected from the group consisting of:
a personal digital assistant having an infrared interface, wherein said first and second communication means are infrared data transmission;
a personal digital assistant having a radio frequency interface, wherein said first and second communication means are radio frequency data transmission.
a magnetic card, wherein said first and second communication means are magnetic card swiping.
a solid state memory device having a standard Universal Serial Bus serial data interface, wherein said first and second communication means are serial data transmission.
a radio frequency tag, wherein said first and second communication means are radio frequency tag proximity communications,
an optical bar code card, wherein said first and second communication means are optical bar code reading, and
a magnetic proximity card, and wherein said first and second communication means are magnetic proximity card reading.

3. A system for rewarding customer loyalty and providing business information to a consumer, comprising:
a consumer subsystem comprising a personal information device wherein the personal information device is comprised of at least a memory storage means for storing customer indicia and storing at least customer indicia;
a central subsystem in communication with the World Wide Web comprising a web server software application in communication with a database server software application, which is in communication with a database;
a business subsystem in communication with the World Wide Web comprising an information exchange unit and a business server having a business server software application and a relational database; wherein said information exchange unit is in communication with said personal information device by a first communication means, and wherein said information exchange unit is in communication with said business server by a second communication means selected from the group consisting of a serial computer interface, a parallel computer interface, a Universal Serial Bus computer interface, a radio frequency computer interface, removable portable magnetic media, removable portable solid state memory media, and a Universal Serial Bus removable portable thumb drive;
wherein said information exchange unit receives said customer indicia stored on said personal information device by said first communication means, and wherein said information exchange unit communicates customer indicia to said business server software application, and wherein said business server software application stores said customer indicia on said relational database, and wherein said business subsystem communicates business information to a consumer by a third communication means.

4. The system of claim 3, wherein said personal information device is selected from the group consisting of:
a personal digital assistant having an infrared interface, wherein said first communication means is infrared data transmission,
a personal digital assistant having a radio frequency interface, wherein said first communication means is radio frequency data transmission,
a magnetic card, wherein said first communication means is magnetic card swiping,
a solid state memory device having a Universal Serial Bus serial data interface, wherein said first communication means is serial data transmission,
a radio frequency tag, and wherein said first communication means is radio frequency tag proximity communications,
an optical bar coded card, wherein said first communication means is optical bar code reading, and
a magnetic proximity card, wherein said first communication means is magnetic proximity card reading.

5. A method for rewarding customer loyalty and providing business information to a consumer, comprising:
generating business information desired to be presented to a consumer,
providing a Business Subsystem having an information exchange unit and a business server, said business server having relational database;
storing said business information on said business server;
providing a personal information device to a consumer having a memory and a first communications means,
storing customer indicia on said personal information device,
presenting said personal information device to said information exchange unit at said place of business,
transmitting customer indicia to information exchange unit by said first communications means,
transmitting said business information to a consumer by a second communications means;
communicating said customer indicia from information exchange unit to said business server relational database.
establishing customer reward criteria,
analyzing customer indicia stored in said relational database to produce a listing containing the identification of customers meeting said reward criteria,
tabulating and producing customer rewards for customers meeting said award criteria, and
transmitting customer reward announcements to customers meeting or exceeding said award criteria via third transmission means.

6. The method of claim 5, further comprising the step of encrypting said customer indicia on said business server relational database.

7. The method of claim 5 or 6, wherein said second communications means is selected from the group consisting of communicating to the personal information device by said first communications means, electronic mail, and mailing of papers; and wherein said third transmission means is selected from the group consisting of mailing of electronic mail and mailing of papers.
